(19) United States
(12) Patent Application Publication
(10) Pub. No.: US 2022/0366482 A1
(43) Pub. Date: Nov. 17, 2022

(54) METHOD OF CENTRALIZING STORAGE RENTAL TRANSACTIONS AND SYSTEM THEREFOR

(71) Applicant: Kenneth Gregory Adams, New Castle, DE (US)

(72) Inventor: Kenneth Gregory Adams, New Castle, DE (US)

(21) Appl. No.: 17/663,501

(22) Filed: May 16, 2022

Related U.S. Application Data
(60) Provisional application No. 63/201,831, filed on May 14, 2021.

(51) Int. Cl. G06Q 30/06; G06Q 30/04; G06Q 20/40; G06Q 20/38

(52) U.S. Cl. CPC G06Q 30/0645; G06Q 30/04; G06Q 20/401; G06Q 20/389

(57) ABSTRACT

A computer implemented method for centralizing comprehensive storage rental transactions includes receiving a search request from a customer for a storage rental business; directing the customer to a webpage displaying available storage units operated by the storage rental business; receiving a rental request from the customer for one of the available storage units; populating a rental application form with information received from the customer; generating a lease agreement between the storage rental business and the customer; obtaining electronic signatures executing the lease agreement; issuing the lease agreement to the customer and to the storage rental business; issuing an access code to the customer for access to the one of the available storage units; billing the customer monthly over a period determined by the lease agreement; receiving payment for the storage unit from the customer; and routing the payment to the storage rental business. The customer has contactless convenience.

### CROSS-REFERENCE TO RELATED APPLICATION

This application claims the benefit of priority of U.S. provisional application No. 63/201,831, filed May 14, 2021, the contents of which are herein incorporated by reference.

### BACKGROUND OF THE INVENTION

The present invention relates to storage rental transactions and, more particularly, to a method and system for centralizing storage rental transactions.

Storage businesses are only as profitable as the number of storage units they have currently renting. In an attempt for the storage business to save time and money, there is normally only one or two managers and/or employees who works at the storage site. Storage business owners also have difficulty absorbing the costs of advertising. Some large operators consistently try to buy smaller operators. As a result of these factors, renting storage is not a user-friendly process.

People do not like to waste time calling only to leave a voice message or driving around wasting fuel and time going to different storage businesses trying to find the right size and price. Moreover, when a customer rents a storage unit, they often have trouble getting help to move their items. Once a unit has been rented, customers may incur late fees for late bill payments. People want convenience and they want it now. During the current pandemic, contactless interactions are highly preferred.

For too long the Self-Storage industry has been behind in technological advancements. Storage businesses are very static. Customers cannot rent a self-storage unit using their smart device nationwide. When people need to move their belongings to storage, they do not reserve a storage unit. Some storage businesses have a reserve now feature. However, practical reservation systems are generally only available for hotels and restaurants.

As can be seen, there is a need for a convenient, nationwide centralized system for researching storage rental and moving services, providing remote reservation of a storage unit, and making payments on a lease.

### SUMMARY OF THE INVENTION

In one aspect of the present invention, a computer implemented method for centralizing comprehensive storage rental transactions comprises receiving a search request from a customer for a storage rental business; directing the customer to a webpage displaying available storage units operated by the storage rental business obtained from a database of storage rental businesses and pack and ship providers; receiving a rental request from the customer for one of the available storage units; populating a rental application form with information received from the customer; generating a lease agreement between the storage rental business and the customer; obtaining electronic signatures executing the lease agreement; issuing the lease agreement to the customer and to the storage rental business; issuing an access code to the customer for access to the one of the available storage units; billing the customer monthly over a period determined by the lease agreement; receiving payment for the one of the available storage units from the customer; and routing the payment to the storage rental business.

In another aspect of the present invention, a system for centralizing comprehensive storage rental transactions comprises a central server including a processor, an internet connection, and a database of storage rental businesses and pack and ship providers; wherein the central server is electronically connected to a payment processing system, the storage rental businesses, and the pack and ship providers; wherein the server is electronically accessible to customers; and wherein the central server is operative to execute the computer implemented method.

The present invention provides a centralizing comprehensive storage rental transactions system, resulting in the largest online self-storage rental marketplace in the United States. This nationwide platform allows customers in any state in the United States to search, find and access a storage unit. Customers may rent a self-storage unit anywhere instantly, anytime—day or night, 24/7—without the hassles normally associated with the rental process. Customers may sign their lease agreement remotely with an electronic signature and move in when they are ready. Customers may obtain help in moving their items into storage and/or in moving locally, regionally, or nationally. Automatic bill payment may eliminate late fees. Free advertising may be provided to participating businesses, allowing them to avoid a direct cost.

These and other features, aspects and advantages of the present invention will become better understood with reference to the following drawings, description, and claims.

### BRIEF DESCRIPTION OF THE DRAWINGS

FIG. 1 is a screenshot of a website operating a method according to an embodiment of the present invention, showing a plurality of quotes;

FIG. 2 is another screenshot thereof, showing selected quotes;

FIG. 3 is another screenshot thereof, showing a sample solicitation to businesses;

FIG. 4 is a schematic view of a system according to an embodiment of the present invention;

FIG. 5 is a flowchart of a storage unit renting method according to an embodiment of the present invention; and

FIG. 6 is a flowchart of a method of obtaining a pack and ship service quote according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a system comprising a centralized platform for self-storage rental where customers may find, rent, and access a storage unit in any state nationwide. This platform gives both large and small operators an equal footing for storage rental. The present invention provides contactless convenience to the customer. Customers may rent directly from a Self-Storage business using their smart device day or night, 24 hrs. a day. The customer may sign the lease agreement and move their items into the unit when they are ready.

The system may comprise a data base of storage rental businesses or storage rental facilities, such as approximately 48,000 businesses, that a customer may search to compare prices. Customers may select a storage business and view the available storage units from that business. In some cases, a size guide may be provided to help the customer determine what size unit to select.

In some embodiments, the customer may obtain insurance for the stored items. The customer may select from available insurance policies.

In some embodiments, the customer may select automatic bill pay by credit card or bank account. The customer provides authorization and credit card or bank account information to enable the transactions. The system bills the customer over a period determined in the lease.

In some embodiments, the system may provide a pack and store service to assist the customer in moving the items into storage.

In some embodiments, a pack and store service may be provided to help customers to move their items locally, regionally, nationally, or internationally, such as when re-locating.

In some embodiments, customers may purchase products indirectly related to storage. For example, a storage business may sell bicycles, toaster ovens, etc. Storage businesses may generate more revenue by selling products not directly related to storage.

In some embodiments, the present invention may comprise a feature that enables customers to sell stored belongings.

In some embodiments, the inventive system may provide a centralized toll-free phone number for customer assistance.

In some embodiments, the present invention may comprise industrial container storage to store tools and equipment for construction sites.

In some embodiments, the present invention provides industrial dumpster rental.

In some embodiments, storage businesses may be provided a retail custom website. An embedded link may also or alternatively be offered to the storage business to display available self-storage units.

In some embodiments, the system may provide the storage business advertisement without direct cost.

In some embodiments, the inventive system may highlight a storage business of the month, directing more traffic to the business for storage unit rental.

In an exemplary embodiment, a process according to the present invention may include the following steps.
1. A Storage business becomes a Partner with an administrator of the inventive system, sometimes referred to herein as “Storage Rentals USA”.
2. The Storage business fills out forms and signs the partner contract with Storage Rentals USA.
3. Storage business uploads business license for verification with Storage Rentals USA.
4. After preliminary review, Storage Rentals USA calls potential Partner for final verification.
5. Final verification includes specific questions on information received by Storage Rentals USA.
6. Partner/Decision Maker Identification is sent a request for instantaneously Identification to be scanned using IntellicheckTM identity authentication and validation technology.
7. Once confirmed and information is correct, Storage business Partner is granted permission to proceed to access Storage Rental USA platform via email.
8. Storage Business customizes their presence on Storage Rentals USA platform by utilizing tools, such as Description of self-storage business, pictures, videos, gate access hours, i.e., complete overview of their self-storage business.
9. Storage business lists self-storage units for online rental.
10. Contracts and lease agreements are backed by DocuSign®, a means of electronically signing documents integrated into Storage Rentals USA Platform, for signatures.
11. Storage Rentals USA advertises in the United States zip code of the partner address, driving customers to Storage Rentals USA website.
12. Customer selects the Partner's business for self-storage rental by submitting a rental request.
13. Customer fills out rental application form and uploads information for self-storage rental.
14. Customer selects unit size, optionally adds insurance, rents the unit and signs the lease agreement by use of DocuSign®.
15. Customer receives gate access code to access storage business and the rented unit.
16. Customer inserts their belongings into the storage unit.
17. Customer is billed monthly with automatic bill pay from their credit or debit card or from their bank account via a payment processing system, reducing late payments
18. Customers may rent from anywhere 24hrs a day, seven days a week using their Mobile phone, iPad® mobile digital device, or Desktop personal computer (PC). Downloading an application is unnecessary.
19. The customer can choose to use a Pack & Store service for help moving their items into storage or moving from one location to another, including Locally, Regionally, or internationally.

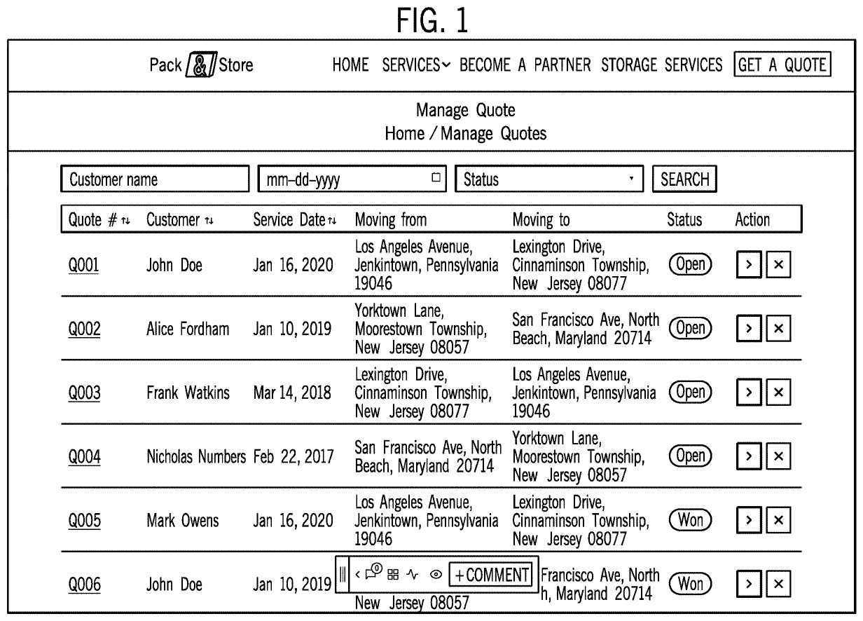

Referring to FIGS. 1 through 6, FIG. 1 shows a webpage providing a centralized storage unit search and a moving service operating a method according to an embodiment of the present invention, displaying a plurality of quotes for the customer to view. The customer is directed to the webpage upon transmitting a search request electronically.

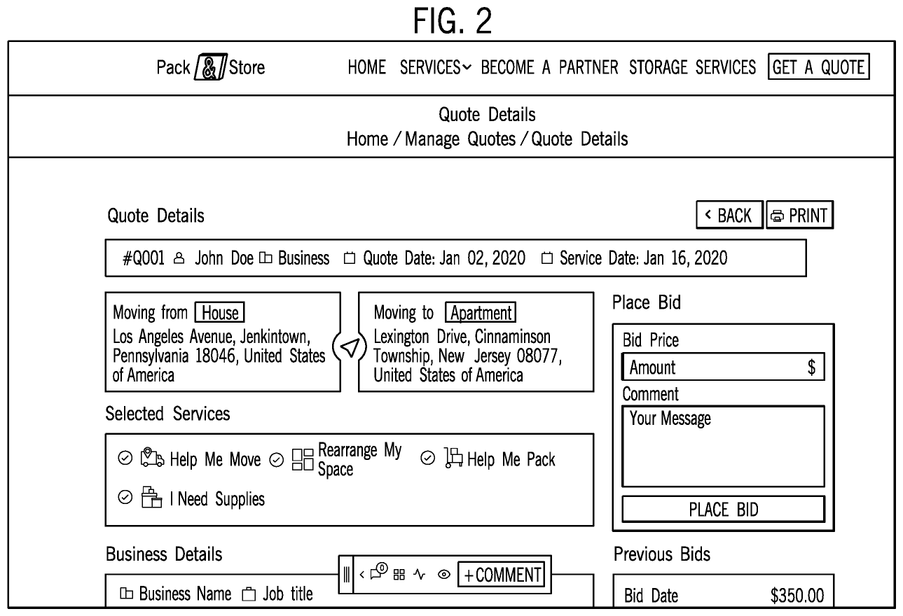

FIG. 2 shows a quote selected from the webpage of FIG. 1 to obtain details.

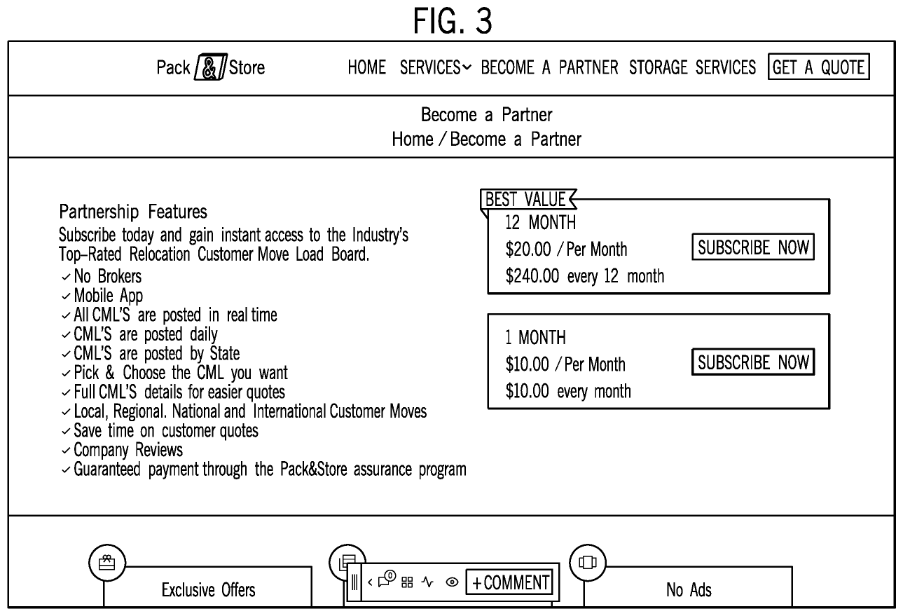

FIG. 3 shows a sample solicitation to businesses to become a partner on a subscription basis.

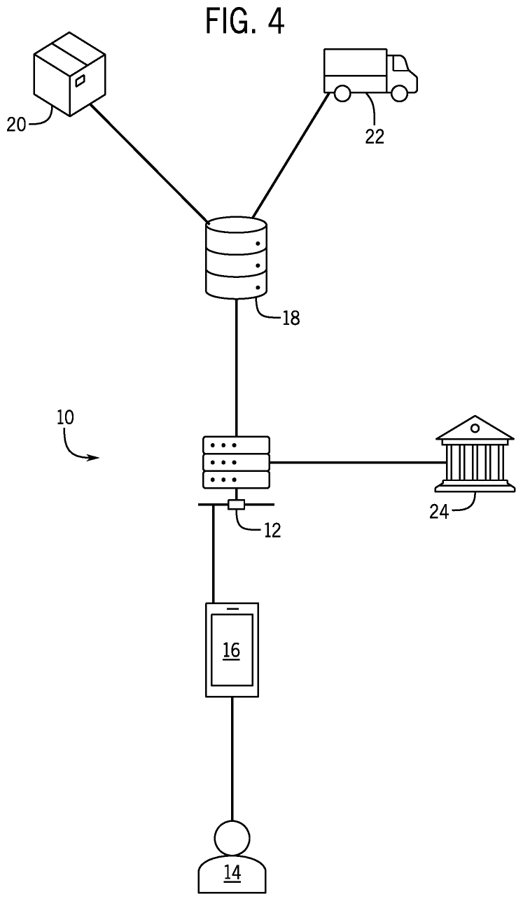

FIG. 4 is a schematic diagram of a system 10 according to the present invention, including a central server 12, including a processor, which is electronically accessible to a customer 14 using a smart device 16 over an internet connection. The central server 12 provides access to a database 18 of storage facilities 20 and pack and ship providers 22. The central server 12 also connects with the customer's 14 bank 24 to obtain payment.

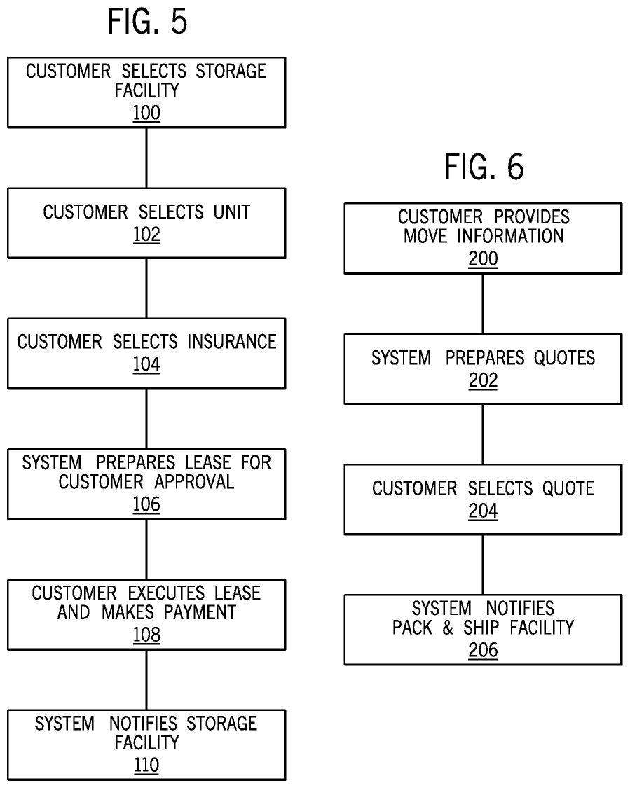

FIG. 5 shows a flow diagram of a method of renting a storage unit with the inventive system. A customer selects a storage facility 100 and a unit 102 as well as insurance 104. The system prepares a lease for the customer's approval 106. The customer executes the lease if satisfactory and makes a payment 108. Once the lease and payment are complete, the system notifies the selected storage facility 110 of the rental.

FIG. 6 shows a flow diagram of a method of obtaining pack and ship service. A customer provides information including the source and destination of the move and the items to be moved 200. The system prepares a series of quotes 202. The customer may view and select any of the quotes 204 associated with one of the pack and ship providers. Once the customer has selected a quote, the system notifies the pack and ship facility of the quote selection that has been accepted 206.

It should be understood, of course, that the foregoing relates to exemplary embodiments of the invention and that modifications may be made without departing from the spirit and scope of the invention as set forth in the following claims.

What is claimed is:

1. A computer implemented method for centralizing comprehensive storage rental transactions, comprising:
a) receiving a search request from a customer for a storage rental business;
b) directing the customer to a webpage displaying available storage units operated by the storage rental business obtained from a database of storage rental businesses and pack and ship providers;
c) receiving a rental request from the customer for one of the available storage units;
d) populating a rental application form with information received from the customer;
e) generating a lease agreement between the storage rental business and the customer;
f) obtaining electronic signatures executing the lease agreement;
g) issuing the lease agreement to the customer and to the storage rental business;
h) issuing an access code to the customer for access to the one of the available storage units;
i) billing the customer monthly over a period determined by the lease agreement;
j) receiving payment for the one of the available storage units from the customer; and
k) routing the payment to the storage rental business.

2. The computer implemented method of claim 1, further comprising, before the step of receiving the search request, receiving a partner contract from the storage rental business and adding the storage rental business to the database.

3. The computer implemented method of claim 1, further comprising retrieving and displaying available insurance policies; receiving a request from the customer for one of the available insurance policies covering items stored in the one of the available storage units; and adding the one of the available insurance policies to the lease agreement.

4. The computer implemented method of claim 1, further comprising receiving authorization and credit card or bank account information from the customer enabling automatic bill payment.

5. The computer implemented method of claim 1, further comprising generating quotes for moving items from a source to a destination from pack and ship providers having data stored on the database; receiving from the customer a quote selection for one of the quotes associated with one of the pack and ship providers; and notifying the one of the pack and ship providers of the quote selection.

6. A system for centralizing comprehensive storage rental transactions, comprising:
a) a central server including a processor, an internet connection, and a database of storage rental businesses and pack and ship providers;
b) wherein the central server is electronically connected to a payment processing system, the storage rental businesses, and the pack and ship providers;
c) wherein the server is electronically accessible to customers; and
d) wherein the central server is operative to execute the computer implemented method of claim 1.
